(19) United States
(12) Patent Application Publication
(10) Pub. No.: US 2026/0179238 A1
(43) Pub. Date: Jun. 25, 2026

(54) SYSTEMS AND METHODS FOR SCENE SCALE NORMALIZATION IN MULTI-VIEW DEPTH ESTIMATION

(71) Applicant: Toyota Research Institute, Inc., Los Altos, CA (US)

(72) Inventors: Vitor Campagnolo Guizilini, Santa Clara, CA (US); Muhammad Zubair Irshad, Milpitas, CA (US); Dian Chen, Mountain View, CA (US); Rares Andrei Ambus, San Francisco, CA (US)

(73) Assignees: Toyota Research Institute, Inc., Los Altos, CA (US); Toyota Jidosha Kabushiki Kaisha, Toyota-shi (JP)

(21) Appl. No.: 19/187,068

(22) Filed: Apr. 23, 2025

Related U.S. Application Data
(60) Provisional application No. 63/737,994, filed on Dec. 23, 2024.

(51) Int. Cl. G06T 7/55; B25J 9/16; G06T 7/80

(52) U.S. Cl. CPC G06T 7/55; B25J 9/1697; G06T 7/80

(57) ABSTRACT

Systems and methods described herein relate to scene scale normalization in multi-view depth estimation. One embodiment is a system that receives input image views from a plurality of cameras and, for each camera in the plurality of cameras, camera intrinsics and camera extrinsics. The system also normalizes the scene scale of the input image views to produce scene-scale-normalized input image views. The system also processes the scene-scale-normalized input image views using a machine-learning-based multi-view depth-estimation model to generate a scene-scale-normalized depth map. The system also injects the scene scale back to the scene-scale-normalized depth map to generate a multi-view-consistent depth map that has the scene scale. The system also controls, at least in part, the operation of a robot based on the multi-view-consistent depth map.

### CROSS-REFERENCE TO RELATED APPLICATION

This application claims the benefit of U.S. Provisional Patent Application No. 63/737,994, “Zero-Shot Novel View and Depth Synthesis with Multi-View Geometric Diffusion,” filed on Dec. 23, 2024, which is incorporated by reference herein in its entirety.

### TECHNICAL FIELD

The subject matter described herein relates in general to three-dimensional (3D) scene reconstruction and, more specifically, to systems and methods for scene scale normalization in multi-view depth estimation.

### BACKGROUND

Some robotics applications involve training a multi-view depth estimation model using mixed-domain training datasets, meaning a mixture of outdoor-robot-related and indoor-robot-related datasets. For example, when a vehicle is traveling along a roadway, the vehicle's cameras move at the rate of meters or tens of meters per second. In contrast, in some indoor-robot-related applications, the camera moves at the rate of centimeters per second. Therefore, some datasets have scales of meters, and other datasets have scales of centimeters. Moreover, some datasets have “metric scale,” meaning that the sizes of objects in a given scene are accurately measured by metric sensors such as Light Detection and Ranging (LIDAR), radar, or sonar sensors, but other datasets have “arbitrary scale” because the scale for those datasets was produced through self-supervision. The differences in scale among datasets make it challenging to train the multi-view depth estimation model.

### SUMMARY

An example of a system for scene scale normalization in multi-view depth estimation is presented herein. The system comprises a processor and a memory storing machine-readable instructions that, when executed by the processor, cause the processor to receive input image views from a plurality of cameras and, for each camera in the plurality of cameras, camera intrinsics and camera extrinsics. The memory also stores machine-readable instructions that, when executed by the processor, cause the processor to normalize the scene scale of the input image views to produce scene-scale-normalized input image views. The memory also stores machine-readable instructions that, when executed by the processor, cause the processor to process the scene-scale-normalized input image views using a machine-learning-based multi-view depth-estimation model to generate a scene-scale-normalized depth map. The memory also stores machine-readable instructions that, when executed by the processor, cause the processor to inject the scene scale back to the scene-scale-normalized depth map to generate a multi-view-consistent depth map that has the scene scale. The memory also stores machine-readable instructions that, when executed by the processor, cause the processor to control, at least in part, the operation of a robot based on the multi-view-consistent depth map.

Another embodiment is a non-transitory computer-readable medium for scene scale normalization in multi-view depth estimation and storing instructions that, when executed by a processor, cause the processor to receive input image views from a plurality of cameras and, for each camera in the plurality of cameras, camera intrinsics and camera extrinsics. The instructions also cause the processor to normalize the scene scale of the input image views to produce scene-scale-normalized input image views. The instructions also cause the processor to process the scene-scale-normalized input image views using a machine-learning-based multi-view depth-estimation model to generate a scene-scale-normalized depth map. The instructions also cause the processor to inject the scene scale back to the scene-scale-normalized depth map to generate a multi-view-consistent depth map that has the scene scale. The instructions also cause the processor to control, at least in part, the operation of a robot based on the multi-view-consistent depth map.

Another embodiment is a method of scene scale normalization in multi-view depth estimation, the method comprising receiving input image views from a plurality of cameras and, for each camera in the plurality of cameras, camera intrinsics and camera extrinsics. The method also includes normalizing the scene scale of the input image views to produce scene-scale-normalized input image views. The method also includes processing the scene-scale-normalized input image views using a machine-learning-based multi-view depth-estimation model to generate a scene-scale-normalized depth map. The method also includes injecting the scene scale back to the scene-scale-normalized depth map to generate a multi-view-consistent depth map that has the scene scale. The method also includes controlling, at least in part, the operation of a robot based on the multi-view-consistent depth map.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is a block diagram of a robot in which various embodiments of the invention can be implemented.

FIG. 2 illustrates an architecture of a multi-view depth estimation system that includes scene scale normalization, in accordance with an illustrative embodiment of the invention.

FIG. 3 illustrates an architecture of a 3D scene reconstruction system, in accordance with an illustrative embodiment of the invention.

FIG. 4 illustrates an example scene, the associated conditioning views, and a target view, in accordance with an illustrative embodiment of the invention.

FIG. 5 is a block diagram of a 3D scene reconstruction system, in accordance with an illustrative embodiment of the invention.

FIG. 6 is a flowchart of a method of scene scale normalization in multi-view depth estimation, in accordance with an illustrative embodiment of the invention.

FIG. 7 is a flowchart of a method of generating a scaled-up and fine-tuned diffusion model for 3D scene reconstruction, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Various embodiments of a three-dimensional (3D) scene reconstruction system are described herein. Some of the various embodiments overcome the problem of disparate scale among different training datasets discussed in the Background through scene scale normalization. In these embodiments, the 3D scene reconstruction system, as a preprocessing technique, normalizes the scale of the input image views before they are processed by a machine-learning-based model (e.g., a diffusion model, in some embodiments), effectively “abstracting the scale away.” The scale is later injected back into the depth maps output by the system. More specifically, the scales of the various datasets are normalized to lie within a unit cube. A computed scale factor (a scalar quantity) used to accomplish this normalization is saved. After the system has generated a scene-scale-normalized depth map, the system scales the geometry of the scene-scale-normalized depth map in accordance with the saved scale factor, yielding a multi-view-consistent depth map. In this context, “consistency” refers to the scale of the output multi-view-consistent depth map being consistent with the cameras that generated the datasets. If those cameras produce metric scale, the multi-view-consistent depth map will also have metric scale. If the cameras produce arbitrary scale, the multi-view-consistent depth map will have matching arbitrary scale. This provides a more stable environment with which to train the machine-learning-based models of the 3D scene reconstruction system because the model being trained always sees the canonicalized (normalized) scale, regardless of the input dataset. The operation of a robot can be controlled, at least in part, based on the multi-view-consistent depth map.

Some of the various embodiments employ techniques to scale up a previously trained diffusion model in size without having to retrain the network from scratch. Instead, the expanded model can be fine-tuned through a relatively small amount of additional training. In these embodiments, the diffusion model includes a bottleneck layer into which the input tokens are projected. These embodiments leverage a special type of neural network called a Recurrent Interface Network (RIN) that uses a learned latent representation to perform the bulk of the computation. Since this RIN network uses attention-based learning, the network is agnostic to the number of latent tokens N (i.e., the operations and weights remain the same, but there are simply more latent tokens to be attended to). Therefore, the capacity of the model can be increased by simply adding more latent tokens. In these embodiments, this is done by duplicating the existing latent tokens of the previously trained diffusion model with their existing weights and concatenating them together to generate a network with twice as many latent tokens (2N) as before. Because the weights have been duplicated, this new network will achieve a very similar performance compared to the original network, since all the same information is present. However, by fine-tuning this scaled-up network through a relatively small amount of additional training, each individual weight is free to specialize, and the scaled-up network quickly converges to a more intricate set of patterns, since the network now has a higher capacity. The operation of a robot can be controlled, at least in part, based on target predictions (e.g., novel views and/or novel depth maps) generated by the scaled-up diffusion model of the 3D scene reconstruction system.

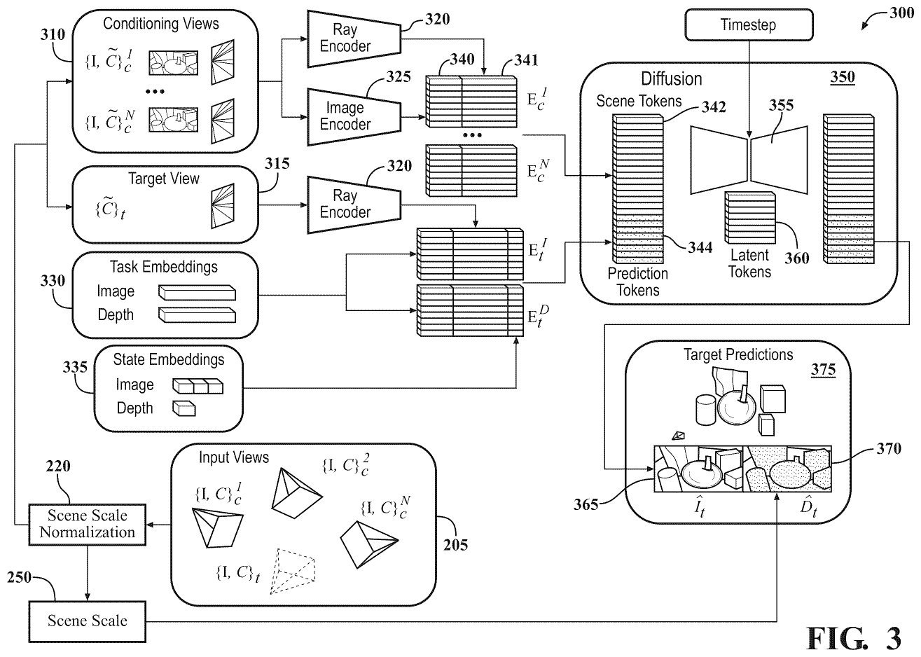

In still other of the various embodiments of a 3D scene reconstruction system described herein (see, e.g., the discussion of FIG. 3 below), scene scale normalization and the techniques for increasing the size of a previously trained diffusion model and fine-tuning the scaled-up diffusion model are used together.

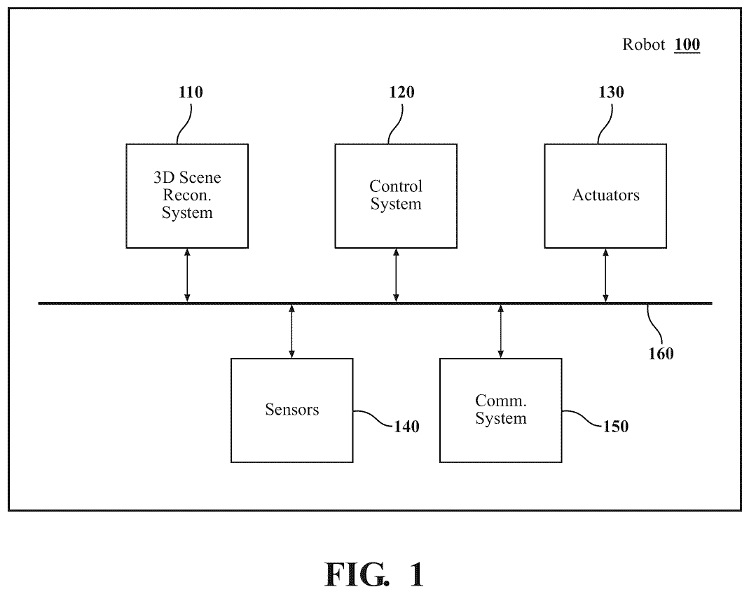

Referring to FIG. 1, it is a block diagram of a robot 100 in which various embodiments of the invention can be implemented. Robot 100 can be any of a variety of different kinds of robots. For example, in some embodiments, robot 100 is a manually driven vehicle equipped with an Advanced Driver-Assistance System (ADAS) or other system that performs analytical and decision-making tasks to assist a human driver. Such a manually driven vehicle is thus capable of semi-autonomous operation to a limited extent in certain situations (e.g., adaptive cruise control, collision avoidance, lane-keeping assistance, lane-change assistance, parking assistance, etc.). In other embodiments, robot 100 is an autonomous vehicle that can operate, for example, at industry defined Autonomy Levels 3-5. In still other embodiments, robot 100 can be a mobile or fixed indoor robot (e.g., a service robot, hospitality robot, companionship robot, manufacturing robot, etc.). The principles and techniques described herein can be deployed in any robot 100 that performs multi-view 3D scene reconstruction. The foregoing examples of robots are not intended to be limiting.

Robot 100 includes various elements. It will be understood that, in various implementations, it may not be necessary for robot 100 to have all the elements shown in FIG. 1. The robot 100 can have any combination of the various elements shown in FIG. 1. Further, robot 100 can have additional elements to those shown in FIG. 1. In some arrangements, robot 100 may be implemented without one or more of the elements shown in FIG. 1, including 3D scene reconstruction system 110. While the various elements are shown as being located within robot 100 in FIG. 1, it will be understood that one or more of these elements can be located external to the robot 100. Further, the elements shown may be physically separated by large distances.

In the embodiment of FIG. 1, 3D scene reconstruction system 110 (hereinafter often referred to as the “generative system 110”) can support or be part of a broader perception system (not shown in FIG. 1) that enables the robot 100 to understand and interpret its surrounding environment. Such a perception system relies on various types of sensors 140 such as, without limitation, cameras, Light Detection and Ranging (LIDAR) sensors, radar sensors, and sonar sensors. In the discussion of various embodiments of a 3D scene reconstruction system 110 below, cameras (e.g., a plurality of conditioning cameras) are particularly relevant. As shown in FIG. 1, the robot 100 also includes a control system 120 and one or more actuators 130 that, in some embodiments, enable the robot 100 to move about within its environment and/or to interact with objects in its environment. In some embodiments, robot 100 includes a communication system 150 through which robot 100 can communicate with other robots, cloud servers, infrastructure devices, etc. In communicating with other devices and systems over a network (not shown in FIG. 1), communication system 150 may employ any of a variety of wired and wireless communication technologies such as Ethernet®, IEEE 802.11 (WiFi), cellular data (LTE, 5G, 6G, etc.), Bluetooth® Bluetooth® Low Energy (Bluetooth® LE), and Dedicated Short-Range Communications (DSRC). In some embodiments, the communication network includes the Internet. Within robot 100, the various elements mentioned above can communicate with one another via one or more data buses 160.

One important function of the communication capabilities of robot 100 is receiving executable program code and model weights and parameters for trained machine-learning-based models (e.g., neural networks) in 3D scene reconstruction system 110. In some embodiments, those machine-learning-based models can be trained on a different system (e.g., a cloud server) at a different location, and the model weights and parameters can be downloaded to robot 100 via communication system 150. Such an arrangement also supports timely software and/or firmware updates.

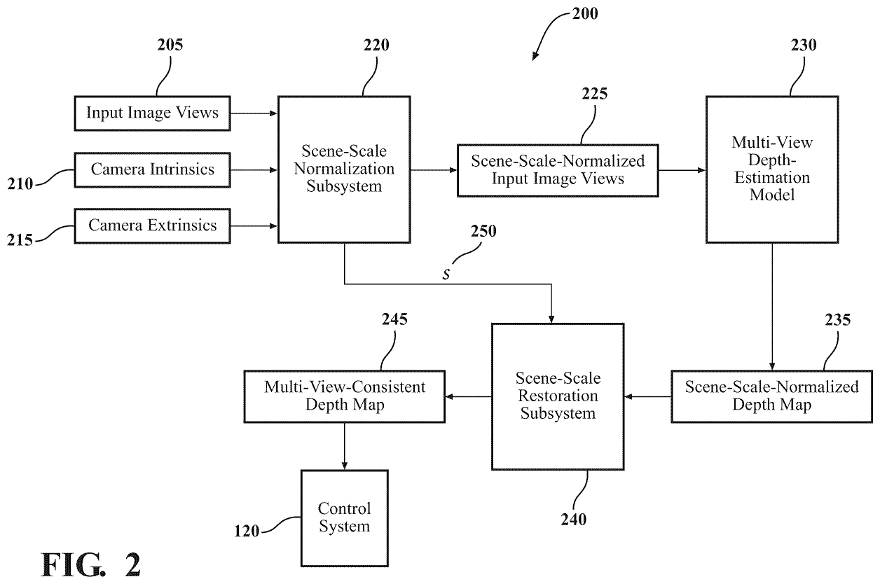

FIG. 2 illustrates an architecture 200 of a multi-view depth estimation system that includes scene scale normalization, in accordance with an illustrative embodiment of the invention. In some embodiments, the architecture 200 is employed in a diffusion-model-based 3D scene reconstruction system such as that discussed below in connection with FIG. 3. In other embodiments, the architecture 200 is employed in a different setting (e.g., in a 3D scene reconstruction system having an architecture different from the architecture 300 shown in FIG. 3).

As shown in FIG. 2, a scene-scale normalization subsystem 220 receives, as input, input image views 205 (e.g., RGB images) of a scene. The input image views 205 can be acquired from a plurality of cameras located at different viewpoints relative to the scene. As discussed above, during training, some of the input image views 205 may be drawn from a dataset having metric scale, whereas others of the input image views 205 may be drawn from a dataset having arbitrary scale. For each camera, scene-scale normalization subsystem 220 also receives, as inputs, camera intrinsics 210 (e.g., focal length, sensor orientation, size and shape of pixels, etc.) and camera extrinsics 215 (e.g., position and orientation in 3D space).

Through a process to be explained in greater detail below in connection with FIG. 3, scene-scale normalization subsystem 220 computes the scene scale 250 (a scalar quantity s) and produces scene-scale-normalized input image views 225 based on the computed scene scale 250. A machine-learning-based multi-view depth-estimation model 230 processes the scene-scale-normalized input image views 225 to generate a scene-scale-normalized depth map 235. As those skilled in the art are aware, a depth map is an image in which each pixel represents the distance between the camera and the corresponding point in the scene.

A scene-scale restoration subsystem 240 injects the saved scene scale 250 back to the scene-scale-normalized depth map 235 to generate a multi-view-consistent depth map 245. As also indicated in FIG. 2, in some embodiments, the multi-view-consistent depth map 245 is used to control, at least in part, the operation of a robot 100 via control system 120. For example, a planning algorithm in the robot 100 can obtain ranging information for objects in the scene from the multi-view-consistent depth map 245 to control the robot's acceleration, deceleration, steering/direction, braking/stopping, etc.

As discussed further below, the scene-scale-normalized depth map 235 is generated by dividing an unnormalized depth map output by the multi-view depth-estimation model 230 by the saved scene scale s (250). Also, in some embodiments, during the training of a multi-view depth estimation system such as that shown in FIG. 2, ground-truth target-camera depth maps are divided by the scene scale s (250) (i.e., normalized in scale) to maintain consistent scene geometry across views. As also discussed further below, the multi-view-consistent depth map 245 is generated by multiplying the scene-scale-normalized depth map 235 by the saved scene scale s (250). This injects the scene scale back to the scene-scale-normalized depth map 235.

At inference time in some embodiments, the multi-view-consistent depth map 245 is a novel depth map associated with a novel target camera (a virtual camera placed in 3D space at a specified position and orientation). A 3D scene reconstruction system can also produce a novel image view that corresponds to the novel depth map.

FIG. 3 illustrates an architecture 300 of a 3D scene reconstruction system 110, in accordance with an illustrative embodiment of the invention. Given a collecuon

$${𝒥}_{C} = {\{ I , 𝒞 \}}_{n = 1}^{N}$$

of input images Iₙ∈ [symbol] ^{H×W×3} (205) and corresponding cameras [symbol] ₙ={K,T} with intrinsics KE [symbol] ^{3×3} (210) and extrinsics T∈ [symbol] ^{4×4} (215), the objective of the 3D scene reconstruction system 110 is to generate a predicted image Îₜ∈ [symbol] ^{H×W×3} (365) and depth map \hat{D}ₜ∈ [symbol] ^{H×W} (370) (sometimes referred to herein collectively as “target predictions”) for a novel target camera [symbol] ₜ and an associated target view 315. The architecture 300 includes a diffusion model ƒ_{θ}˜p(Îₜ,\hat{D}ₜ| [symbol] ₜ, [symbol] _{C}) to learn a conditional distribution from which to sample novel target images 365 and novel depth maps 370. Various aspects of the architecture 300 are discussed in detail below.

Diffusion models operate by learning a state transition function from a noise tensor E to a sample x₀ from a learned data distribution, as defined in the following equation: xₜ=\sqrt{αₜ}x₀+\sqrt{1−αₜ}ϵ (“Equation 1”), where ϵ˜ [symbol] (0, [symbol] ),

$${α}_{t} = {\prod }_{s = 1}^{t} ( 1 - {β}_{s} ) , and {\{ {β}_{t} \}}_{t = 1}^{T}$$

is the variance schedule for a process with T steps. A neural network \hat{ϵ}=ƒ_{θ}(xₜ,t,c) is trained to estimate the noise \hat{ϵ}ₜ added to a sample x₀ at timestep t, given a conditioning variable c used to control the generative process. At inference time, a novel x₀ is reconstructed from a normally-distributed variable x_{T}˜ [symbol] (0, [symbol] ) by iteratively applying the learned transition function ƒ_{θ} over T steps.

In some embodiments, the architecture 300 is implemented using a RIN, an efficient transformer-based architecture. One aspect of such an implementation is the separation of computation into input tokens X∈ [symbol] ^{N×D} (scene tokens 342 and prediction tokens 344) and latent tokens Z∈ [symbol] ^{L×D} (360), where the former are obtained by tokenizing input data (and thus depend on the input size N), but L is a fixed dimension. At each RIN block, the latent tokens Z (360) are first cross-attended with the inputs X, followed by several self-attention layers on Z, and the resulting latent tokens Z (360) are cross-attended back with X. That the bulk of the computation (i.e., self-attention) operates on a fixed number L of latent tokens 360 rather than on all N input tokens makes it affordable to learn ƒ_{θ} directly in pixel space. It also enables the use of significantly more conditioning views to generate the scene tokens 342. Also, as discussed above, RIN latent tokens 360 can be incrementally expanded (e.g., doubled in number through duplication) to allow the training of larger models by fine-tuning smaller models with promising scaling behavior in terms of performance versus complexity.

The discussion of architecture 300 next turns to the mathematical details of the scene scale normalization techniques discussed above in connection with FIG. 2. In the embodiment of FIG. 3, scene scale normalization is a preprocessing operation performed on the input image views 205 before they are processed by the diffusion model 350. First, the conditioning-camera extrinsics

$${T}_{c}^{n}$$

(215) are expressed relative to the novel target-camera extrinsics Tₜ so that

$${\tilde{T}}_{c}^{n} = {T}_{c}^{n} {T}_{t}^{- 1} ,$$

which means that the novel normalized target camera [symbol] ₜ={K,\tilde{T}}ₜ is always positioned at the origin. This enforces translational and rotational invariance to scene-level coordinate changes, a property that has been shown to improve multi-view depth estimation.

As discussed above, the scene scale s (250) is defined as a scalar quantity representing the largest absolute camera translation in any spatial coordinate, i.e.,

$$s = max {\{ {\{ \vert \tilde{x} \vert , \vert \tilde{y} \vert , \vert \tilde{z} \vert \}}_{c}^{n} \}}_{n = 1}^{N} , where {t}_{c}^{n} = {[ x , y , z ]}^{T}$$

is the translation component of

$${T}_{c}^{n} = [ \begin{matrix}R & t \\ 0 & 1\end{matrix} ] , and {R}_{c}^{n} ∈ {ℝ}^{3 \times 3}$$

is its rotational component. Scene-scale normalization subsystem 220 divides all translation vectors by the scene scale s, such that

$${\tilde{t}}_{c}^{n} = {[ x / s , y / s , z / s ]}^{T} .$$

Referring to the discussion of FIG. 2 above, a scene-scale-normalized depth map 235 can be generated through division by s, and a scene-scale-normalized depth map 235 (e.g., an output novel depth map) can be converted to a multi-view-consistent depth map 245 through multiplication by s (i.e., by injecting the scene scale back to the scene-scale-normalized depth map 235). As also mentioned above, during training, if a target depth map Dₜ is used as ground truth, scene-scale normalization subsystem 220 also divides it by s to keep the scene geometry consistent across views, such that \tilde{D}ₜ=Dₜ/s. If max{\tilde{D}ₜ}>dₘₐₓ (the maximum value estimated by the model), scene-scale normalization subsystem 220, in some embodiments, recalculates the scene scale 250 as s′=s. Dₘₐₓ/max{\tilde{D}ₜ} so the normalized ground-truth is within range, and this new value is used to recalculate

$${\{ {t}_{c}^{n} \}}_{n = 1}^{N} .$$

During inference, 3D scene reconstruction system 110, once \hat{D}ₜ has been generated, multiplies \hat{D}ₜ by s to ensure consistency with the conditioning cameras that produce the conditioning views 310. In other words, the generated depth maps (245) will have the same scale as the conditioning cameras.

In some embodiments, image encoder 325 uses an EfficientViT (Efficient Vision Transformer) to tokenize the input conditioning views 310, providing visual scene information for novel generation. In some embodiments, image encoder 325 begins as a pretrained EfficientViT-SAM-L2 model taken from the official repository. That pretrained model is then fine-tuned end-to-end during training. A H×W input image I will result in

$${F}_{I} ∈ {ℝ}^{\frac{H}{4} \times \frac{W}{4} \times 448}$$

features. These features are flattened and processed by a linear layer

$${ℒ}_{448 \to {D}_{I}}^{I}$$

to produce image embeddings

$${E}_{c}^{I , n} ∈ {ℝ}^{\frac{HW}{16} \times {D}_{I}}$$

(340). This process is repeated for each conditioning view, resulting in N sets of image embeddings 340.

In some embodiments, the ray encoders 320 use Fourier encoding to tokenize input cameras, parameterized as a raymap containing origin

$${t}_{ijk} = {[ x , y , z ]}_{k}^{T}$$

and viewing direction rᵢⱼₖ=(KₖRₖ)⁻¹[uᵢⱼ,vᵢⱼ]^{T} for each pixel pᵢⱼ from camera k. This information is used to (a) position features extracted from conditioning views 310 in 3D space and (b) determine novel viewpoints for image and depth synthesis. Conditioning cameras [symbol] ₙ are resized to match the resolution of image embeddings 340, and the target camera [symbol] ₜ is kept the same. Note that tₜ is at the origin, and Rₜ= [symbol] . Assuming Nₒ and Nᵣ origin and ray frequencies, respectively, the resulting ray embeddings 341 are of dimensionality D_{R}=3(Nₒ+Nᵣ+1).

Note that the architecture 300 does not rely on intermediate 3D representations. Instead, architecture 300 generates novel renderings directly from an implicit model that is multi-view consistent. This is accomplished by jointly learning novel view and novel depth synthesis—by directly rendering depth maps from novel viewpoints alongside images. The architecture 300 uses learnable task embeddings E^{task}∈ [symbol] ^{D}^{ₜₐₛₖ} (330) to guide each individual generation toward a specific task. How the model's predictions are parameterized is explained further below, depending on the task.

First, for a target image 365 (predicted multi-view image), the pixel-level diffusion of the architecture 300 does not require latent auto-encoders. Therefore, ground-truth images are simply normalized to [−1,1] with P_{RGB}=(I+1)/2. Generated predictions can be converted back to images using the inverse operation Î=2\hat{P}_{RGB}+1.

Second, for a target depth map 370 (predicted multi-view depth map), the generated depth predictions are scale-aware to preserve multi-view consistency. In some embodiments, architecture 300 uses log-scale parameterization (top equation below), and predictions are converted back using the inverse operation (bottom equation below).

$${P}_{D} = 2 ( log ( \frac{D}{s \cdot {d}_{min}} ) / log ( \frac{{d}_{max}}{{d}_{min}} ) ) - 1$$

$$\hat{D} = exp ( ( 2 {\hat{P}}_{D} + 1 ) log ( \frac{{d}_{max}}{{d}_{min}} ) ) {d}_{min} \cdot s$$

In one embodiment, dₘᵢₙ=0.1, and dₘₐₓ=200, which makes architecture 300 suitable for both indoor and outdoor scenarios. Note, however, that those values are not metric, since they are considered after the scene scale normalization (220) discussed above.

The operations described above produce two different sets of inputs: scene tokens 342 that contextualize the diffusion process and prediction tokens 344 that guide the diffusion process toward generating the desired predictions (e.g., a target image 365 and/or a target depth map 370).

Scene tokens 342 are obtained by first concatenating the image embeddings 340 and the ray embeddings 341 from each conditioning view 310, producing

$${E}_{c}^{n} = {E}_{c}^{I , n} ⊕ {E}_{c}^{R , n} ,$$

and then concatenating embeddings from all conditioning views 310, producing

$${E}_{c} = {E}_{c}^{1} ⊕ … ⊕ {E}_{c}^{N} ∈ {ℝ}^{\frac{NHW}{16} \times ( {D}_{1} + {D}_{R} )} .$$

In some embodiments, architecture 300 improves the training efficiency by randomly sampling Mₛ scene tokens 342 as conditioning.

Prediction tokens 344 are obtained by concatenating ray embeddings

$${E}_{t}^{R}$$

from the target (virtual) camera with the desired task embeddings E^{task} (330) and state embeddings

$${S}_{t}^{task}$$

335. The state embeddings 335 contain the evolving state of the diffusion model's predictions, as defined further below.

During the training phase, state embeddings Sₜ are generated by parameterizing an input image Iₜ or depth map Dₜ and adding random noise determined by a noise scheduler n(t), given a randomly sampled timestep t∈[1,T]. In some embodiments, the diffusion model is trained to learn the transition function ƒ_{θ} according to Equation 1 above. In some embodiments, L2 and L1 losses are used to supervise image and depth-map generation, respectively. For depth estimation, prediction tokens 344 are generated for pixels with valid ground-truth. In some embodiments, the efficiency of both tasks is improved by randomly sampling Mₚ prediction tokens 344.

At inference, state embeddings

$${S}_{t}^{T} ∼ 𝒩 ( 0 , )$$

(335) are sampled as three-dimensional vectors for image synthesis or as scalars for depth generation. They are iteratively denoised for T steps using ƒ_{θ} with scheduler n(t). At t=0, state embeddings

$${S}_{t}^{0}$$

will contain the parameterized prediction, which is converted back to Îₜ (365) or \hat{D}ₜ (370). In some embodiments, to mitigate stochasticity, the architecture 300 includes performing test-time ensembling over E=5 samples.

As discussed above, the fixed dimensionality of the latent tokens Z (360) enables efficient training and inference in terms of the number of input tokens X. As explained above, introducing more latent tokens 360 does not change the fundamental architecture 300 because the cross-attention with inputs and self-attention between latent tokens 360 remains the same. Therefore, after training with a specific number of latent tokens 360, the generative system 110 can simply duplicate and concatenate the latent tokens 360 with their existing (already trained) weights, resulting in a structurally similar representation with twice the capacity. This scaled-up model can then be further optimized through a relatively small amount of additional training (i.e., without having to retrain the enlarged model from scratch). In one embodiment, there are initially 256 latent tokens 360, and the model is scaled up through repeated doubling of the latent tokens 360 and fine-tuning through additional training until a model with 2048 latent tokens 360 has been created. In other words, the process of doubling the number of latent tokens 360 and fine-tuning the scaled-up diffusion model 350 through additional training can be repeated one or more times, in some embodiments.

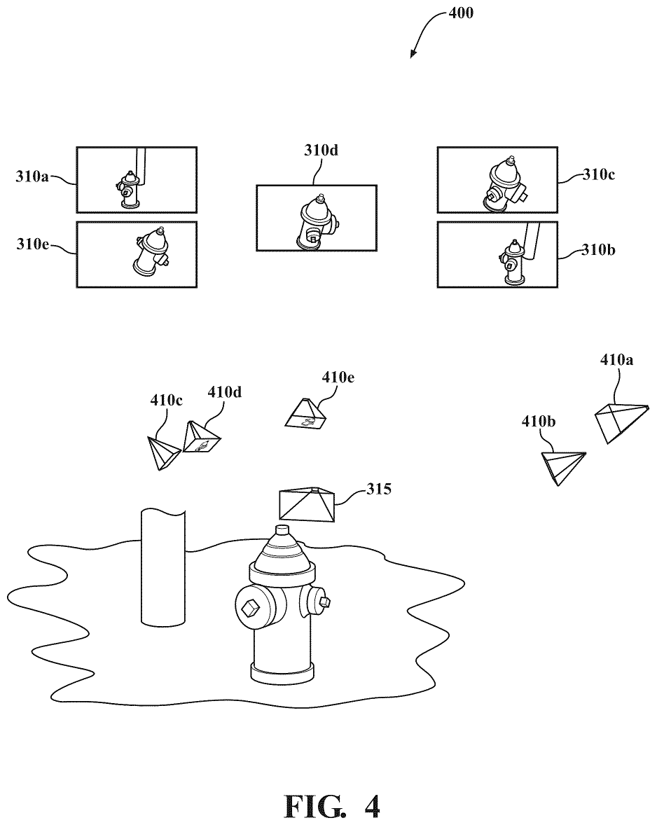

FIG. 4 illustrates an example scene 400, the associated conditioning views 310, and a target view 315, in accordance with an illustrative embodiment of the invention. In this example, the scene 400 depicts a fire hydrant near a pole. The input conditioning views 310 for the scene 400 are shown, in FIG. 4, as conditioning views 310a-e. The corresponding camera viewpoints from which the conditioning views 310a-e were captured are shown as conditioning-camera viewpoints 410a-e, respectively. Additionally, an illustrative target view 315 is also shown. In this example, the task of the generative system 110 is to generate an image (365) from the perspective of the target view 315 based on the conditioning views 310a-e. As discussed above, in the embodiment of FIG. 3, the generative system 110 processes the input views 205 to generate scene tokens 342 and prediction tokens 344 and then applies a diffusion-based model 350 to generate a target image 365 and/or target depth map 370 based on the specified target view 315. Through this approach, the generative system 110 is able to generate novel views and depth maps without relying on an intermediate 3D representation, as discussed above.

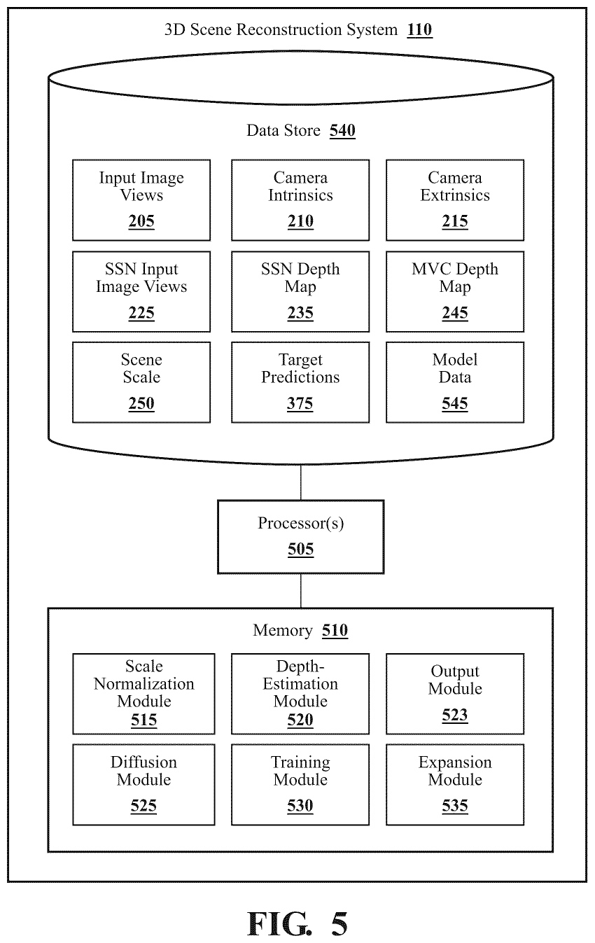

FIG. 5 is a block diagram of a 3D scene reconstruction system 110, in accordance with an illustrative embodiment of the invention. As explained above, though FIGS. 1 and 2 depict the generative system 110 as being deployed in a robot 100, some aspects of the generative system 110 are, in some embodiments, developed or configured on a different computing system in a different (possibly remote) location and downloaded to robot 100. Examples include the weights and parameters of various computational and machine-learning-based models included in the generative system 110.

In FIG. 5, the generative system 110 is shown as including one or more processors 505. The one or more processors 505 may coincide with one or more processors of robot 100 (not shown in FIG. 1), the generative system 110 may include one or more processors that are separate from the one or more processors of robot 100, or the generative system 110 may access the one or more processors 505 through a data bus or another communication path, depending on the embodiment.

Generative system 110 also includes a memory 510 communicably coupled to the one or more processors 505, the memory 510 storing machine-readable instructions. The machine-readable instructions stored in memory 510 include a scale normalization module 515, a depth-estimation module 520, an output module 523, a diffusion module 525, a training module 530, and an expansion module 535. The memory 510 is a random-access memory (RAM), read-only memory (ROM), a hard-disk drive, a flash memory, or other suitable memory for storing the modules 515, 520, 523, 525, 530 and 535. The modules 515, 520, 523, 525, 530 and 535 are, in some embodiments, machine-readable instructions that, when executed by the one or more processors 505, cause the one or more processors 505 to perform the various functions disclosed herein. In other embodiments, the functionality of the modules 515, 520, 523, 525, 530 and 535 is implemented, at least in part, using hardware components such as one or more gate arrays and/or one or more application-specific integrated circuits (ASICs).

In connection with its tasks, the generative system 110 can store various kinds of data in a data store 540. For example, in the embodiment shown in FIG. 5, generative system 110 stores, in the data store 540, input image views 205, camera intrinsics 210, camera extrinsics 215, scene-scale-normalized (SSN) input image views 225, scene-scale-normalized (SSN) depth maps 235, scene scale 250, model data 545, target predictions 375 (e.g., target images 365 and/or target depth maps 370), and multi-view-consistent (MVC) depth maps 245. Model data 545 includes a variety of different kinds of hyperparameters, parameters, scene tokens 342, prediction tokens 344, latent tokens 360, and other data associated with the machine-learning-based models (e.g., a diffusion model 350) of the 3D scene reconstruction system 110.

Scale normalization module 515 generally includes machine-readable instructions that, when executed by the one or more processors 505, cause the one or more processors 505 to receive input image views 205 from a plurality of cameras and, for each camera in the plurality of cameras, camera intrinsics 210 and camera extrinsics 215, as discussed above in connection with FIGS. 2 and 3. Scale normalization module 515 also includes machine-readable instructions that, when executed by the one or more processors 505, cause the one or more processors 505 to normalize the scene scale of the input image views 205 to produce scene-scale-normalized input image views 225.

Depth-estimation module 520 generally includes machine-readable instructions that, when executed by the one or more processors 505, cause the one or more processors 505 to process the scene-scale-normalized input image views 225 using a machine-learning-based multi-view depth-estimation model 230 to generate a scene-scale-normalized depth map 235.

Scale normalization module 515 discussed above also includes machine-readable instructions that, when executed by the one or more processors 505, cause the one or more processors 505 to inject the scene scale 250 back to the scene-scale-normalized depth map 235 to generate a multi-view-consistent depth map 245 that has the scene scale 250.

Output module 523 generally includes machine-readable instructions that, when executed by the one or more processors 505, cause the one or more processors 505 to control, at least in part, operation of a robot 100 based on the multi-view-consistent depth map 245. For example, a planning algorithm in the robot 100 can obtain ranging information for objects in the scene from the multi-view-consistent depth map 245. In some embodiments, output module 523 controls the operation of the robot 100 via the control system 120 of the robot 100, as discussed above.

Expansion module 535 generally includes machine-readable instructions that, when executed by the one or more processors 505, cause the one or more processors 505, in a previously trained diffusion model 350 that includes a latent space (part of a bottleneck layer 355) containing a plurality of latent tokens 360, to double the number of latent tokens 360 by duplicating the plurality of latent tokens 360 to create a scaled-up diffusion model 350 having a higher (i.e., twice the) capacity.

Training module 530 generally includes machine-readable instructions that, when executed by the one or more processors 505, cause the one or more processors 505 to fine-tune the scaled-up diffusion model through additional training, as discussed above in connection with FIG. 3.

Diffusion module 525 generally includes machine-readable instructions that, when executed by the one or more processors 505, cause the one or more processors 505 to process, using the fine-tuned scaled-up diffusion model 350, scene tokens 342 and prediction tokens 344 generated from conditioning views 310 and a target view 315 of a scene to generate target predictions 375 (e.g., target images 365 and/or target depth maps 370).

Output module 523 discussed above includes additional machine-readable instructions that, when executed by the one or more processors 505, cause the one or more processors 505 to control, at least in part, operation of a robot based on the target predictions 375. For example, a planning algorithm in the robot 100 can obtain important information about the identity of objects or the presence of obstacles in a scene, including ranging information, from the target predictions 375. In some embodiments, output module 523 controls the operation of the robot 100 via the control system 120 of the robot 100, as discussed above.

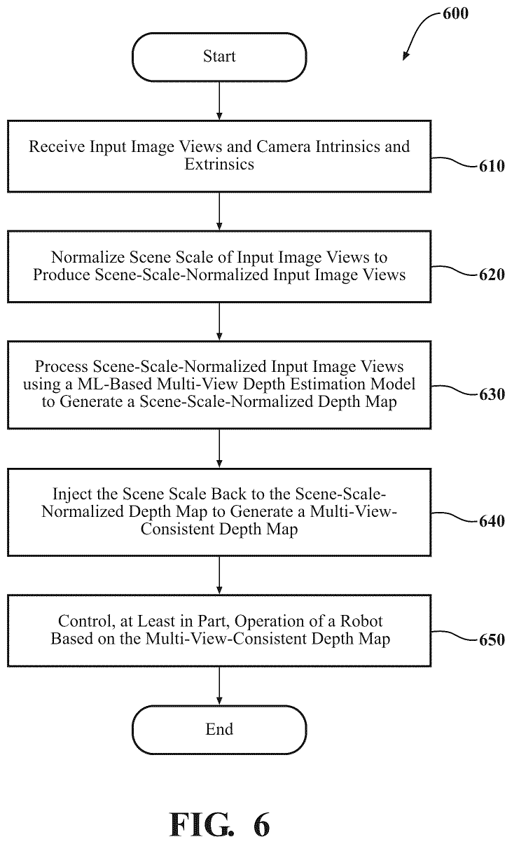

FIG. 6 is a flowchart of a method 600 of scene scale normalization in multi-view depth estimation, in accordance with an illustrative embodiment of the invention. Method 600 will be discussed from the perspective of the 3D scene reconstruction system 110 in FIG. 5 with reference to FIGS. 1-3. While method 600 is discussed in combination with the generative system 110, it should be appreciated that method 600 is not limited to being implemented within the generative system 110, but the generative system 110 is instead one example of a system that may implement method 600.

At block 610, scale normalization module 515 receives input image views 205 from a plurality of cameras and, for each camera in the plurality of cameras, camera intrinsics 210 and camera extrinsics 215, as discussed above in connection with FIGS. 2 and 3

At block 620, scale normalization module 515 normalizes the scene scale of the input image views 205 to produce scene-scale-normalized input image views 225. This is discussed in detail above in connection with FIGS. 2 and 3.

At block 630, depth-estimation module 520 processes the scene-scale-normalized input image views 225 using a machine-learning-based multi-view depth-estimation model 230 to generate a scene-scale-normalized depth map 235. This is discussed in detail above in connection with FIGS. 2 and 3.

At block 640, scale normalization module 515 injects the scene scale 250 back to the scene-scale-normalized depth map 235 to generate a multi-view-consistent depth map 245 that has the scene scale 250. This is discussed in detail above in connection with FIGS. 2 and 3.

At block 650, output module 523 controls, at least in part, operation of a robot 100 based on the multi-view-consistent depth map 245. For example, a planning algorithm in the robot 100 can obtain ranging information for objects in the scene from the multi-view-consistent depth map 245. This is discussed further above in connection with FIG. 2. In some embodiments, output module 523 controls the operation of the robot 100 via the control system 120 of the robot 100, as discussed above.

As discussed above, in some embodiments, method 600 also includes, during the training of the multi-view depth-estimation model 230, scale normalization module 515 dividing a ground-truth target-camera depth map by s (250) to maintain consistent scene geometry across views. That is, scale normalization module 515 normalizes the scale of such a ground-truth target-camera depth map.

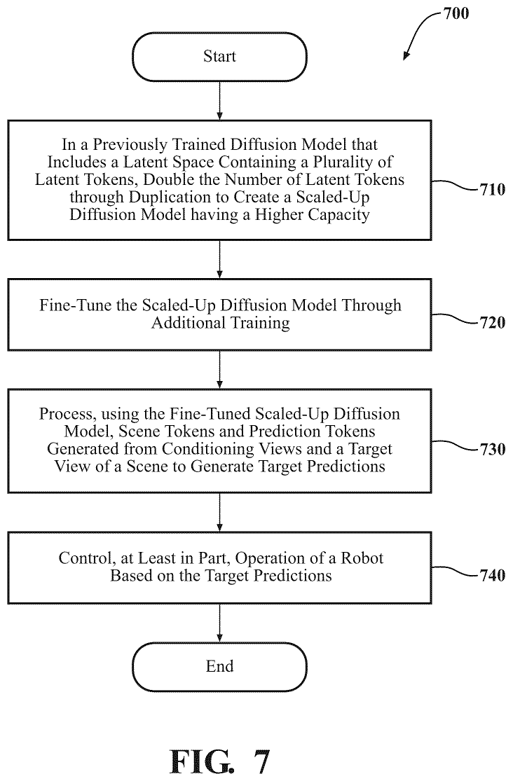

FIG. 7 is a flowchart of a method of generating a scaled-up and fine-tuned diffusion model 350 for 3D scene reconstruction, in accordance with an illustrative embodiment of the invention. Method 700 will be discussed from the perspective of the 3D scene reconstruction system 110 in FIG. 5 with reference to FIGS. 1, 3, and 4. While method 700 is discussed in combination with the generative system 110, it should be appreciated that method 700 is not limited to being implemented within the generative system 110, but the generative system 110 is instead one example of a system that may implement method 700.

At block 710, expansion module 535, in a previously trained diffusion model 350 that includes a latent space (part of a bottleneck layer 355) containing a plurality of latent tokens 360, doubles the number of latent tokens 360 by duplicating the plurality of latent tokens 360 to create a scaled-up diffusion model 350 having a higher (i.e., twice the) capacity.

At block 720, training module 530 fine-tunes the scaled-up diffusion model 350 through additional training, as discussed above in connection with FIG. 3.

At block 730, diffusion module 525 processes, using the fine-tuned scaled-up diffusion model 350, scene tokens 342 and prediction tokens 344 generated from conditioning views 310 and a target view 315 of a scene to generate target predictions 375 (e.g., target images 365 and/or target depth maps 370).

At block 740, output module 523 controls, at least in part, operation of a robot 100 based on the target predictions 375. For example, a planning algorithm in the robot 100 can obtain important information about the identity of objects or the presence of obstacles in a scene, including ranging information, from the target predictions 375. In some embodiments, output module 523 controls the operation of the robot 100 via the control system 120 of the robot 100, as discussed above.

As discussed above in connection with FIG. 3, in some embodiments, the doubling of the latent tokens 360 and fine-tuning through additional training can be repeated one or more times. That is, the latent tokens 360 in the diffusion model 350 can be doubled and the resulting scaled-up model can be fine-tuned through additional training multiple times (e.g., from 256 latent tokens 360 to 512, from 512 latent tokens 360 to 1024, from 1024 latent tokens 360 to 2048, etc.).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims rather than to the foregoing specification, as indicating the scope hereof.

What is claimed is:

1. A system, comprising:
a processor; and
a memory storing machine-readable instructions that, when executed by the processor, cause the processor to:
receive input image views from a plurality of cameras and, for each camera in the plurality of cameras, camera intrinsics and camera extrinsics;
normalize a scene scale of the input image views to produce scene-scale-normalized input image views;
process the scene-scale-normalized input image views using a machine-learning-based multi-view depth-estimation model to generate a scene-scale-normalized depth map;
inject the scene scale back to the scene-scale-normalized depth map to generate a multi-view-consistent depth map that has the scene scale; and
control, at least in part, operation of a robot based on the multi-view-consistent depth map.

2. The system of claim 1, wherein the machine-readable instructions to normalize the scene scale of the input image views include instructions that, when executed by the processor, cause the processor to:
position a novel target camera at the origin of a coordinate system by multiplying a conditioning-camera-extrinsics matrix by the inverse of a target-camera-extrinsics matrix;
determine, as the scene scale, a scalar value s that represents a largest absolute conditioning-camera translation in any spatial coordinate of the coordinate system; and
divide conditioning-camera translation vectors by s.

3. The system of claim 2, wherein the machine-readable instructions include further instructions that, when executed by the processor, cause the processor, during training of the machine-learning-based multi-view depth-estimation model, to divide a ground-truth target-camera depth map by s to maintain consistent scene geometry across views.

4. The system of claim 2, wherein the machine-readable instructions to inject the scene scale back to the scene-scale-normalized depth map to generate the multi-view-consistent depth map include instructions that, when executed by the processor, cause the processor to multiply the scene-scale-normalized depth map by s.

5. The system of claim 4, wherein the multi-view-consistent depth map is a novel depth map associated with the novel target camera.

6. The system of claim 1, wherein, during training of the machine-learning-based multi-view depth-estimation model, some of the input image views are drawn from a dataset having metric scale and others of the input image views are drawn from a dataset having arbitrary scale.

7. The system of claim 1, wherein the robot is one of a vehicle and an indoor robot.

8. A non-transitory computer-readable medium storing instructions that, when executed by a processor, cause the processor to:
receive input image views from a plurality of cameras and, for each camera in the plurality of cameras, camera intrinsics and camera extrinsics;
normalize a scene scale of the input image views to produce scene-scale-normalized input image views;
process the scene-scale-normalized input image views using a machine-learning-based multi-view depth-estimation model to generate a scene-scale-normalized depth map;
inject the scene scale back to the scene-scale-normalized depth map to generate a multi-view-consistent depth map that has the scene scale; and
control, at least in part, operation of a robot based on the multi-view-consistent depth map.

9. The non-transitory computer-readable medium of claim 8, wherein the instructions to normalize the scene scale of the input image views include instructions that, when executed by the processor, cause the processor to:
position a novel target camera at the origin of a coordinate system by multiplying a conditioning-camera-extrinsics matrix by the inverse of a target-camera-extrinsics matrix;
determine, as the scene scale, a scalar value s that represents a largest absolute conditioning-camera translation in any spatial coordinate of the coordinate system; and
divide conditioning-camera translation vectors by s.

10. The non-transitory computer-readable medium of claim 9, wherein the non-transitory computer-readable medium includes further instructions that, when executed by the processor, cause the processor, during training of the machine-learning-based multi-view depth-estimation model, to divide a ground-truth target-camera depth map by s to maintain consistent scene geometry across views.

11. The non-transitory computer-readable medium of claim 9, wherein the instructions to inject the scene scale back to the scene-scale-normalized depth map to generate the multi-view-consistent depth map include instructions that, when executed by the processor, cause the processor to multiply the scene-scale-normalized depth map by s.

12. The non-transitory computer-readable medium of claim 11, wherein the multi-view-consistent depth map is a novel depth map associated with the novel target camera.

13. The non-transitory computer-readable medium of claim 8, wherein, during training of the machine-learning-based multi-view depth-estimation model, some of the input image views are drawn from a dataset having metric scale and others of the input image views are drawn from a dataset having arbitrary scale.

14. A method, comprising:
receiving input image views from a plurality of cameras and, for each camera in the plurality of cameras, camera intrinsics and camera extrinsics;
normalizing a scene scale of the input image views to produce scene-scale-normalized input image views;
processing the scene-scale-normalized input image views using a machine-learning-based multi-view depth-estimation model to generate a scene-scale-normalized depth map;
injecting the scene scale back to the scene-scale-normalized depth map to generate a multi-view-consistent depth map that has the scene scale; and
controlling, at least in part, operation of a robot based on the multi-view-consistent depth map.

15. The method of claim 14, wherein the normalizing the scene scale of the input image views includes:
positioning a novel target camera at the origin of a coordinate system by multiplying a conditioning-camera-extrinsics matrix by the inverse of a target-camera-extrinsics matrix;
determining, as the scene scale, a scalar value s that represents a largest absolute conditioning-camera translation in any spatial coordinate of the coordinate system; and
dividing conditioning-camera translation vectors by s.

16. The method of claim 15, further comprising, during training of the machine-learning-based multi-view depth-estimation model, dividing a ground-truth target-camera depth map by s to maintain consistent scene geometry across views.

17. The method of claim 15, wherein the injecting the scene scale back to the scene-scale-normalized depth map to generate the multi-view-consistent depth map includes multiplying the scene-scale-normalized depth map by s.

18. The method of claim 17, wherein the multi-view-consistent depth map is a novel depth map associated with the novel target camera.

19. The method of claim 14, wherein, during training of the machine-learning-based multi-view depth-estimation model, some of the input image views are drawn from a dataset having metric scale and others of the input image views are drawn from a dataset having arbitrary scale.

20. The method of claim 14, wherein the robot is one of a vehicle and an indoor robot.
